(19) United States
(12) Patent Application Publication
(10) Pub. No.: US 2025/0374252 A1
(43) Pub. Date: Dec. 4, 2025

(54) WIRELESS COMMUNICATION SYSTEM AND DYNAMIC ALLOCATION OF FREQUENCY INDEX VALUES

(71) Applicant: Charter Communications Operating, LLC, St. Louis, MO (US)

(72) Inventors: Prabhath Narayanan Nair, Parker, CO (US); Vijay K. Mechineni, Parker, CO (US)

(21) Appl. No.: 18/679,728

(22) Filed: May 31, 2024

(51) Int. Cl. H04W 72/0453; H04W 74/00

(52) U.S. Cl. CPC H04W 72/0453; H04W 74/002

(57) ABSTRACT

A system as discussed herein includes communication management hardware. The communication management hardware: receive notification of a change in wireless bandwidth allocated for use by a first wireless network, the change detected based on reassignment of second wireless bandwidth as a substitute to previously allocated first wireless bandwidth; in response to the notification of the change, produce configuration information indicating multiple frequency index values associated with use of a random-access channel; and distribute the configuration information to entities in the first wireless network.

### BACKGROUND

Conventional wireless networks typically include one or more wireless base stations or wireless access points to provide mobile communication devices (a.k.a., user equipment) access to a remote network such as the Internet or other target communication devices and remote locations. In certain instances, the wireless networks include many different types of networks and/or components that must collectively work together to provide wireless services.

One conventional type of wireless network is a 5G wireless network. A 5G wireless network typically includes at least one so-called 5G radio access network (RANs) and corresponding 5G core network. A conventional 5G wireless base station may be connected to a 5G core network via an IP (Internet Protocol) network commonly referred to as a backhaul. 5G networks implement dynamic policy to enforce behaviors on user traffic.

One way to implement a 5G wireless network is use of allocated wireless channels in a CBRS (Citizen Band Radio System) communication system. In such a system, an incumbent entity (such as a communication device operated by the government) has higher priority rights to use wireless channels than a so-called PAL (Priority Access License) user and a GAA (General Authorized Access). The PAL users have higher priority access rights than GAA users.

According to conventional techniques, in the case where the incumbent entity uses wireless channels, the SAS (Spectrum Access System) will enforce a CBSD (Citizen Broadband System Device) service provider to either reduce bandwidth or stop transmission.

User equipment such as mobile communication devices use the conventional RACH (Random Access CHannel) process to perform initial access to a respective gNB (such as wireless base station or 5G Radio). The random-access channel supports connectivity between communication devices and respective base stations. For example, when a communication device wants to wirelessly connect to a network for the first time or after a period of inactivity, it transmits communications over the random-access channel to request access to the network.

In a conventional CBRS networks, there is high chance of dynamic bandwidth changes from SAS to CBRS 5G radios, due to incumbent activities and PAL providers. In a conventional CBRS network, frequency start values such as so-called MGS1FS messages use fixed values.

### BRIEF DESCRIPTION

There are deficiencies associated with conventional techniques of implementing wireless networks as discussed above. For example, in case of a respective SAS reduces bandwidth from 40 MHz to 20 MHz for specific set of radios, if assigned MGS1FS is more than 1st 4 values (such as 0, 12, 24, 36), the UE (User Equipment) will not be provided access and cannot connect to network due to RACH failures. This results in a poor user experience.

Techniques as discussed herein provide better use of wireless resources and, more particularly, better use of a random-access channel supporting new wireless connectivity in a network environment.

For example, a communication management resource receives notification of a change in wireless bandwidth allocated for use by a first wireless network. The change is detected based on reassignment of second wireless bandwidth as a substitute to previously allocated first wireless bandwidth. In response to the notification of the change, the communication management resource produces configuration information indicating multiple frequency index values associated with use of a random-access channel. The communication management resource then distributes the configuration information and corresponding frequency index values to different entities in the first wireless network.

In one example, the reassignment of the second wireless bandwidth for use by the first wireless network as a substitute to the first wireless bandwidth results in less bandwidth assigned for use by the first wireless network. For example, the first wireless network may be initially allocated a first wireless bandwidth of 40 megahertz; the first wireless network may subsequently be allocated use of only 20 megahertz. A magnitude of the number of frequency index values (such as specifying offsets with respect to a base frequency value) associated with the random-access channel varies depending on the magnitude of the allocated wireless bandwidth. For example, eight random-access channel index values (offset values) such as 0, 12, 24, 36, 48, 60, 72, and 84 may be assigned for use by the first wireless network during a condition in which the first wireless bandwidth of 40 megahertz is assigned for use. The reduction in the allocated bandwidth from 40 megahertz to 20 megahertz results in a corresponding reduction in the number of random-access channel index values 0, 12, 24, and 36 for use by the first wireless network.

Conversely, note that an increase in the allocated wireless bandwidth may result in an increase in the number of random-access channel index values assigned for use by the first wireless network.

In accordance with further examples, the change (such as reduction from 40 megahertz to 20 megahertz) in the wireless bandwidth allocated for use by the first wireless network may occur in response to detected use of the first wireless bandwidth by an incumbent entity having higher priority rights than the first wireless network.

Yet further, distribution of the configuration information as discussed herein may include the communication management resource or other suitable entity communicating the configuration information indicating the multiple frequency index values to multiple wireless base stations in the first wireless network, the first wireless network operated by a first service provider. As previously discussed, the multiple frequency index values assigned for use by the first wireless network and corresponding wireless base stations may include a number, N, frequency index values, where the number N is an integer value proportional to a magnitude of the second bandwidth.

Still further, as previously discussed, each respective frequency index value of the multiple frequency index values may be an offset frequency value.

In accordance with further examples as discussed herein, the communication management resource can be used to receive the notification of the change in wireless bandwidth from any suitable entity such as an allocation management resource operative to allocate use of bandwidth to multiple wireless networks including the first wireless network and a second wireless network in a network environment. In one example, the communication management resource as discussed herein is implemented in a host domain proxy allocating use of wireless channels from a tiered priority allocation system.

In yet further examples as discussed herein, the communication management resource or other suitable entity can be configured to produce the configuration information (configuration settings indicating frequency index values) to include first configuration settings and a second configuration settings. The first configuration settings may include a first assigned RSI (Root Sequence Index) option and a first start frequency index value; the second configuration settings may include a second assigned RSI option and a second start frequency index value. Communication of the configuration from the communication management resource may include transmission of the first configuration settings to a first wireless base station in the first wireless network and transmission of the second configuration settings to a second wireless base station in the first wireless network.

As previously discussed, the one or more start frequency index values assigned to the wireless base station may depend upon a magnitude of the newly allocated wireless bandwidth assigned for use by the respective wireless base station.

Note that the random-access channel as discussed herein is allocated/configured to enable multiple communication devices to establish a respective wireless communication link with one or more wireless base stations in the network environment.

In another example as discussed herein, a first wireless network may include multiple wireless base stations such as a first wireless base station, second wireless base station, etc. The first wireless base station receives configuration settings indicating allocation of second wireless bandwidth to support communications in a network environment. Assume that the allocation of the second wireless bandwidth is a substitute to first wireless bandwidth previously allocated for use by the first wireless base station. The configuration information in this example indicates a first frequency index value and a first root sequence index assigned to the first wireless base station for use of a shared random-access channel supported by multiple wireless base stations. The first wireless base station transmits the configuration information in a message from the first wireless base station to one or more mobile communication devices within wireless range of the first wireless station. The configuration information transmitted from the first wireless base station notifies the one or more mobile communication devices how the random-access channel is to be used when trying to establish a wireless communication link between the respective mobile communication device and the first wireless station.

In one example, the message (such as one or more communications) including the configuration information may further include a unique identifier value (such as a PCI value for Physical Cell Identifier) assigned to the first wireless base station. The message notifies one or more communication devices in a vicinity of the first wireless base station how to communicate with the first wireless base station over the random-access channel supported by the first wireless base station to establish a wireless communication link with the first wireless base station.

Still further, note that the second wireless bandwidth may be allocated for use by the first wireless base station in response to detected use of the first wireless bandwidth by an incumbent entity having higher priority rights with respect to use of the first wireless bandwidth than the first wireless base station.

In another example, transmission of the configuration information in the one or more messages from the first wireless base station includes broadcasting the one or more messages from the first wireless base station. In such an instance, any mobile communication devices receiving the one or more messages are aware how to use the corresponding random-access channel to establish a respective wireless communication link with the first wireless base station.

As previously discussed, the dynamically assigned frequency index value included in the message transmitted from the first wireless base station is selected from a number N frequency index values, where the number N is an integer value proportional to an amount of the second bandwidth. Further, as previously discussed, the first frequency index value (such as a so-called start value) included in the message from the first wireless base station can be configured to indicate an offset with respect to a base frequency value.

Techniques as discussed herein are useful over conventional techniques. For example, one or more implementation of a communication management resource and corresponding operations as discussed herein provide better use of supporting a random-access channel shared by multiple different entities in the network.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including a non-transitory computer-readable storage medium or any computer readable hardware storage medium on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium or computer readable hardware storage such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are directed to a method, system, computer program product, etc., that supports operations as discussed herein.

One example includes computer readable storage hardware having instructions stored thereon. The instructions, when executed by corresponding computer processor hardware, cause the computer processor hardware (such as one or more co-located or disparately processor devices or hardware) to: receive notification of a change in wireless bandwidth allocated for use by a first wireless network, the change detected based on reassignment of second wireless bandwidth as a substitute to previously allocated first wireless bandwidth; in response to the notification of the change, produce configuration information (such as first configuration settings, second duration settings, etc.) indicating multiple frequency index values associated with use of a random-access channel; and distribute the configuration information to entities (such as wireless base stations) in the first wireless network.

Another example includes computer readable storage hardware having instructions stored thereon. The instructions, when executed by corresponding computer processor hardware, cause the computer processor hardware (such as one or more co-located or disparately processor devices or hardware) to: receive configuration settings associated with allocation of second wireless bandwidth to support communications in a network environment, the allocation of the second wireless bandwidth being a substitute to first wireless bandwidth previously allocated to a first wireless base station, the configuration information further indicating a frequency index value and a root sequence index assigned for use in a random-access channel supported by a first wireless base station; and transmit the configuration information from the first wireless base station in a message from the first wireless base station.

The ordering of the steps above has been added for clarity sake. Note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of controlling conveyance of data packets via service flows in a network environment. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a network environment implementing dynamic configuration of frequency index values based on allocated bandwidth as discussed herein.

FIG. 2 is an example diagram illustrating bandwidth versus frequency index information as discussed herein.

FIG. 3 is an example diagram illustrating RSI (Root Sequence Index) information as discussed herein.

FIG. 4 is an example diagram illustrating a random-access channel and implementation of frequency indexes as discussed herein.

FIG. 5 is an example diagram illustrating assignment of different RSI information and frequency index values to different wireless base stations based on allocation of first bandwidth as discussed herein.

FIG. 6 is an example diagram illustrating a network environment implementing dynamic configuration of frequency index values based on reduced wireless bandwidth allocation as discussed herein.

FIG. 7 is an example diagram illustrating assignment of different RSI information and frequency index values to different wireless base stations based on allocation of second wireless bandwidth as discussed herein.

FIG. 8 is an example diagram illustrating a network environment implementing dynamic configuration of frequency index values based on reduced wireless bandwidth allocation as discussed herein.

FIG. 9 is an example diagram illustrating assignment of different RSI information and frequency index values to different wireless base stations based on allocation of the third wireless bandwidth as discussed herein.

FIG. 10 is an example diagram illustrating example computer hardware and software operable to execute operations as discussed herein.

FIG. 11 is an example diagram illustrating a method as discussed herein.

FIG. 12 is an example diagram illustrating a method as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

In case of bandwidth change from SAS, gNB (such as wireless base station) can be configured with logic such as including so-called Auto RACH mechanism or as part of SON (Self Optimizing Network) feature that should check the currently assigned frequency index value (such as MSGIFS) and dynamically re-assign a new frequency index value based on new bandwidth enforced by SAS.

The so-called Auto RACH module in the wireless base station may include logic to check corresponding neighbor configuration settings for RSI+MGS1FS values and select a value which is not or less used by its configured neighboring sites to avoid RACH collisions.

For example, if gNB bandwidth changes from 40 MHz to 10 MHz, it should select MSG1FS from 0 or 12 only, in case bandwidth change is from 40 MHz to 20 MHz, select MSG1FS from 0,12,24,and 36.

By adding dynamically selecting frequency index values associated with the RACH process, techniques herein provide optimization of networks, resulting in better user service experience having less RACH failures, RSI collisions, and sleepy cell issues.

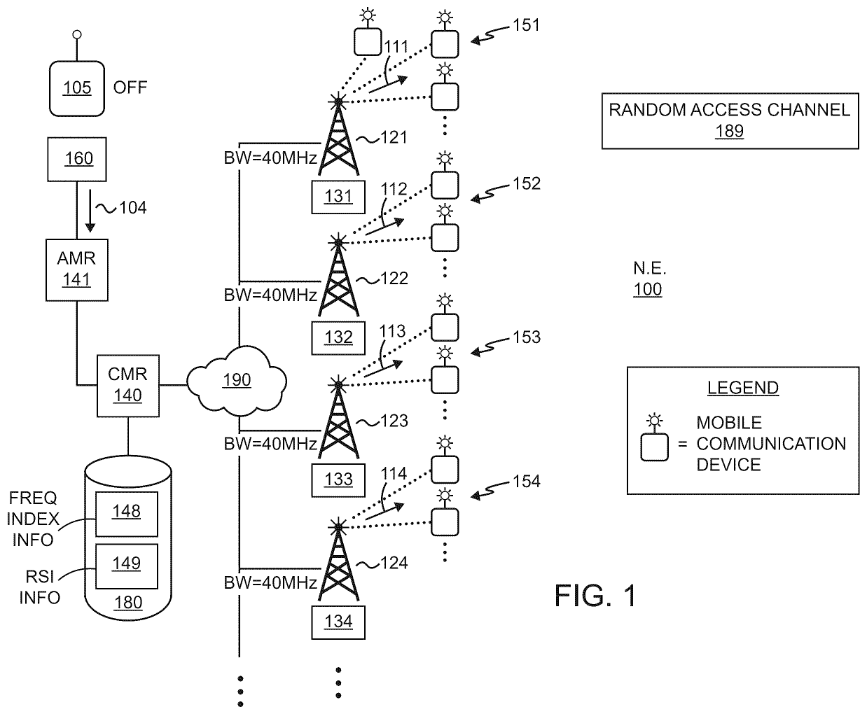

Now, more specifically, with reference to the drawings, FIG. 1 is an example diagram illustrating a network environment implementing multiple wireless base stations providing wireless network access as discussed herein.

As shown in FIG. 1, the network environment 100 includes monitor resource 160 (such as so-called environmental sensing capability), allocation management resource 141 such as a spectrum access system, network 190, communication management resource 140 such as an EMS (Element Management System) or domain proxy, repository 180, multiple wireless base stations (such as wireless base station 121, wireless base station 122, wireless base station 123, wireless base station 124, etc.), and multiple groups of mobile communication devices 151, 152, 152, 154, etc. Repository 180 stores available frequency index information 148 and RSI information 149.

As further shown, as their names suggest, the communication management resource 131 manages communications and operations associated with the wireless base station 121; the communication management resource 132 manages communications and operations associated with the wireless base station 122; the communication management resource 133 manages communications and operations associated with the wireless base station 123; the communication management resource 134 manages communications and operations associated with the wireless base station 124; and so on.

Note that each of the resources as discussed herein can be configured as hardware, software, or a combination of hardware and software. For example, the monitor resource 160 can be implemented as monitor hardware, monitor software, or a combination of monitor hardware and monitor software; the allocation management resource 141 can be implemented as allocation management hardware, allocation management software, or a combination of allocation management hardware and allocation management software; the communication management resource 140 can be configured as communication management hardware, communication management software, or a combination of communication manager hardware and communication management software; wireless base station 121 can be implemented as corresponding communication management hardware, communication management software, or a combination of communication management hardware and communication management software; wireless base station 122 can be implemented as corresponding communication management hardware, communication management software, or a combination of communication manager hardware and communication management software; wireless base station 123 can be implemented as corresponding communication management hardware, communication management software, or a combination of communication management hardware and communication management software; wireless base station 124 can be implemented as corresponding communication management hardware, communication management software, or a combination of communication manager hardware and communication management software; communication management resource 131 can be configured as communication management hardware, communication management software, or a combination of communication management hardware and communication management software; communication management resource 132 can be configured as communication management hardware, communication management software, or a combination of communication management hardware and communication management software; any of the communication devices can be implemented as communication hardware, communication software, or a combination of communication hardware and communication software; and so on.

In one example, the network environment 100 and corresponding wireless base stations as discussed herein provide wireless connectivity to respective communication devices based on wireless channels (wireless bandwidth) allocated from available wireless bandwidth. The wireless channels (a.k.a., wireless bandwidth) use by the wireless base stations can be allocated from any suitable wireless band. In one example, each of the wireless base stations supports 5G wireless communications (or any other suitable protocol of communications) via use of a respective allocated CBRS (Citizen

Broadband Radio Service) channels. The Citizens Broadband Radio Service (CBRS) is a 150 MHz wide (such as 15 channels of 10 megahertz for each channel) broadcast band of the 3.5 GHz band (3550 MHz to 3700 MHz).

Thus, the channel allocation management resource 140 can be configured to allocate any of the channels (wireless bandwidth) such as channel #1 (CH1), channel #2 (CH2), etc., from a respective tiered hierarchy in which an incumbent entity 105 has highest priority rights use of any of the wireless channels such channels; so-called PAL (Priority Access License) users have second highest priority rights in use of any of the wireless channels; and so-called GAA users have lowest priority rights to use the channels.

The monitor resource 160 can be configured to monitor use of one or more wireless channels by a respective incumbent entity 105. If the monitor resource 160 detects use of wireless channels by the incumbent entity 105, the monitor resource 160 provides notification of same such as via communications 104 to the allocation management resource 140 regarding the use of wireless channels by the incumbent entity 105. Conversely, when one or more wireless channels are no longer used by the incumbent entity 105, the monitor resource 160 provides notification of the discontinued use to the allocation management resource 141 via communications 104.

As its name suggests, based on the availability as indicated by the allocation management resource 141, the allocation management resource 140 allocates one or more wireless channels for use by the wireless base stations and corresponding communication devices.

More specifically, as previously discussed, the allocation management resource 140 is configured to receive input such as communications 104 from the monitor resource 160 indicating whether or not any of wireless channels are being used by a respective incumbent entity 105. In this example, assume that no incumbent entity 105 currently uses wireless bandwidth. In such an instance, the allocation management resource 140 allocates use of four 10 MHz wireless channels (such as 40 megahertz bandwidth) for use by the first wireless network including wireless base station 121, wireless base station 122, wireless base station 113, wireless base station 124, etc.

Based on the allocated bandwidth of 40 megahertz, the communication management resource 140 uses the frequency index information 148 and the RSI information 149 stored in the repository 180 to configure the first wireless network of multiple base stations.

For example, the network environment 100 supports use of a respective random-access channel 189 used (shared) by the different sets of communication devices to establish wireless connectivity with each of the wireless base stations. The communication management resource 140 can be configured to produce configuration settings for each of the different wireless base stations based on the allocated 40 megahertz of bandwidth, which is shared by the multiple wireless base stations.

Each of the wireless base stations can be configured to support wireless connectivity with multiple communication devices. For example, based on the allocation of the 40 megahertz bandwidth: i) the wireless base station 121 provides the set of mobile communication devices 151 wireless access to the network 190; ii) the wireless base station 122 provides the set of mobile communication devices 152 wireless access to the network 190; iii) the wireless base station 123 provides the set of mobile communication devices 153 wireless access to the network 190; and so on.

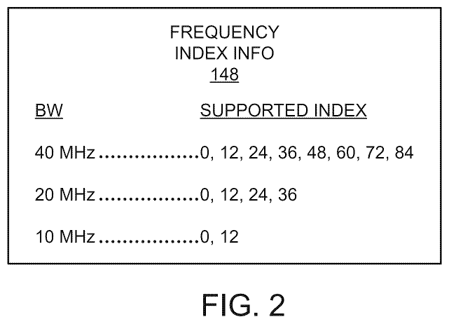

Frequency index information associated with use of the random-access channel 189 is further shown in FIG. 2.

FIG. 2 is an example diagram illustrating bandwidth versus frequency index information as discussed herein.

This example illustrates different sets of the frequency index values available for respective different amounts of allocated wireless bandwidth.

For example, when allocated 40 megahertz bandwidth such as four 10 megahertz channels, the communication management resource 140 has available 8 different frequency index values (frequency offset values) such as 0, 12, 24, 36, 48, 60, 72, and 84. Each index value indicates a frequency offset value in the frequency domain with respect to a base frequency value to use the random-access channel 189.

When allocated 20 megahertz of bandwidth, the communication management resource 140 has available 4 different frequency index values such as 0, 12, 24, and 36.

When allocated 10 megahertz of bandwidth, the communication management resource 140 has available for different frequency index values such as 0 and 12.

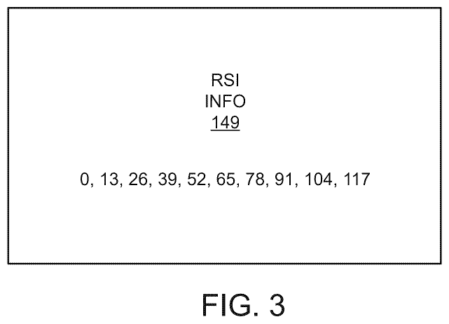

FIG. 3 is an example diagram illustrating RSI (Root Sequence Index) information as discussed herein.

As shown, the RSI information 149 includes multiple different RSI values 0, 13, 26, 39, 52, 65, 78, 91, 104, and 117, available for assignment to the different wireless base stations. Thus there are a total of 10 available RSI values in this example. In one embodiment, the Root Sequence Index is used to determine 64 physical RACH preamble sequences available in the cell. These preambles may be generated to have a series of root sequences. The root sequence index value assigned to the respective wireless base station identifies the corresponding first root sequence that the cell (wireless base station) is actually sign for use.

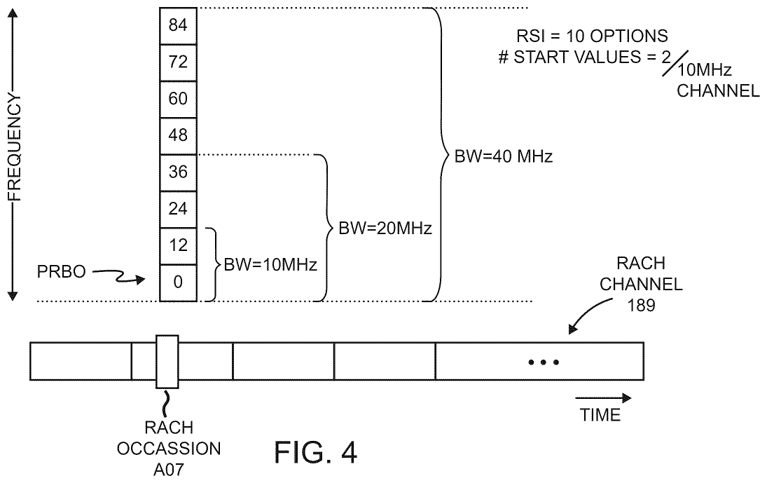

Additional details of implementing different frequency index values for different bandwidth is shown in FIG. 4.

FIG. 4 is an example diagram illustrating a random-access channel and implementation of frequency indexes as discussed herein.

As previously discussed, there are 2 offset frequency index values for each 10 megahertz of allocated bandwidth.

Assume in this example that the first wireless network including wireless base station 121, wireless base station 122, wireless base station 123, wireless base station 124, etc., is assigned use of the RACH occasion 407 (time slot) in the RACH channel 189.

Upon any bandwidth assignment changes, each wireless base station in the first wireless network is preferably assigned a unique combination of a frequency index value as well as an RSI value.

Thus, when the communication management resource 140 is assigned 40 megahertz bandwidth, there are a total of 80 (X1 times Y) unique combinations of frequency index values (X1=8) and RSI values (Y=10) for up to 80 wireless base stations. This means that the first wireless network may include 80 wireless base stations, each assigned a unique combination of frequency index value and RSI value.

When the communication management resource 140 is assigned 20 megahertz bandwidth, there are a total of 40 (X2 times Y) unique combinations of frequency index values (X2=4) and RSI values (Y=10) for up to 40 wireless base stations. This means that the first wireless network may include 40 base stations, each assigned a unique combination of frequency index value and RSI value.

When the communication management resource 140 is assigned 10 megahertz bandwidth, there are a total of 20 (X3 times Y) unique combinations of frequency index values (X3=2) and RSI values (Y=10) for up to 20 wireless base stations. This means that the first wireless network may include 20 base stations, each assigned a unique combination of frequency index value and RSI value.

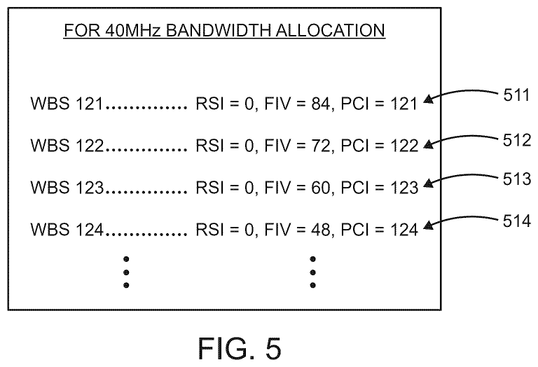

FIG. 5 is an example diagram illustrating assignment of different RSI information and frequency index values to different wireless base stations based on allocation of first bandwidth as discussed herein.

Based on allocation of the 40 megahertz, the communication management resource 140 produces respective configuration settings for each of the wireless base stations in the first wireless network. As previously discussed, it is desirable to assign a unique combination of RSI value and frequency index value to each wireless base station in the first wireless network. This ensures that the communication devices attempting to establish wireless connectivity communicate a request in the appropriate manner over the random-access channel 189 to the desirable wireless base station.

In this example, as previously discussed, there are 80 possibilities of assigning combinations of on RSI and frequency index value to a respective wireless base station for the assigned 40 megahertz bandwidth.

For example, based on the allocation of 40 megahertz, the communication management resource 140 generates configuration settings 511 to indicate that the wireless base station 121 has been assigned an RSI of 0, frequency index value 84, PCI (Physical Cell Identity or unique identifier value) of 121, RACH occasion 407, etc. The communication management resource 140 forwards the configuration settings 511 associated with the random-access channel 189 to the wireless base station 121. The wireless base station 121 then broadcasts (communications 111) all or a portion of the configuration settings 511 to any listening communication devices 151. Via the configuration settings 511, the receiving communication devices are then aware of how to use the random-access channel to obtain wireless resources associated with the wireless base station 121. For example, any of the communication devices 151 that wish to establish a respective wireless communication link with the wireless base station 121 or obtain uplink wireless resources to communicate with the wireless base station 121 use the received configuration settings 511 (RSI 0, frequency index value=84, etc.) to obtain the wireless uplink resources to communicate with the wireless base station 121. For example, to establish connectivity with the wireless base station 121, the respective communication device communicates a request message in the RACH occasion 407 (time slot) of the RACH channel 189 at a frequency associated with the frequency index value 84 using a preamble associated with the RSI value of 0.

Based on the allocation of 40 megahertz, the communication management resource 140 generates configuration settings 512 to indicate that the wireless base station 122 has been assigned an RSI of 0, frequency index value 72, PCI (Physical Cell Identity or unique identifier value) of 122, RACH occasion 407, etc. The communication management resource 140 forwards the configuration settings 512 associated with the random-access channel 189 to the wireless base station 122. The wireless base station 122 then broadcasts (such as via communications 112) all or a portion of the configuration settings 512 to any listening communication devices 152. The receiving communication devices are then aware of how to use the random-access channel to obtain wireless resources associated with the wireless base station 122. Any of the communication devices 152 that wish to establish a respective wireless communication link with the wireless base station 122 or obtain uplink wireless resources to communicate with the wireless base station 122 use the received configuration settings 512 (RSI 0, frequency index value=72, etc.) to obtain the wireless uplink resources to communicate with the wireless base station 122. For example, the communication device communicates a request in the assigned RACH occasion 407 of the RACH channel 189 at a frequency associated with the frequency index value 72 using a preamble associated with the RSI value of 0.

Based on the allocation of 40 megahertz, the communication management resource 140 generates configuration settings 513 to indicate that the wireless base station 123 has been assigned an RSI of 0, frequency index value 60, PCI (Physical Cell Identity or unique identifier value) of 123, RACH occasion 407, etc. The communication management resource 140 forwards the configuration settings 513 associated with the random-access channel 189 to the wireless base station 123. The wireless base station 123 then broadcasts (such as via communications 113) all or a portion of the configuration settings 513 to any listening communication devices 152. The receiving communication devices are then aware of how to use the random-access channel to obtain wireless resources associated with the wireless base station 123. Any of the communication devices 152 that wish to establish a respective wireless communication link with the wireless base station 123 or obtain uplink wireless resources to communicate with the wireless base station 123 use the received configuration settings 513 (RSI 0, frequency index value=72, etc.) to obtain the wireless uplink resources to communicate with the wireless base station 123. For example, the communication device communicates a request (message) in the RACH occasion 407 of the RACH channel 189 at a frequency associated with the frequency index value 72 using a preamble associated with the RSI value of 0.

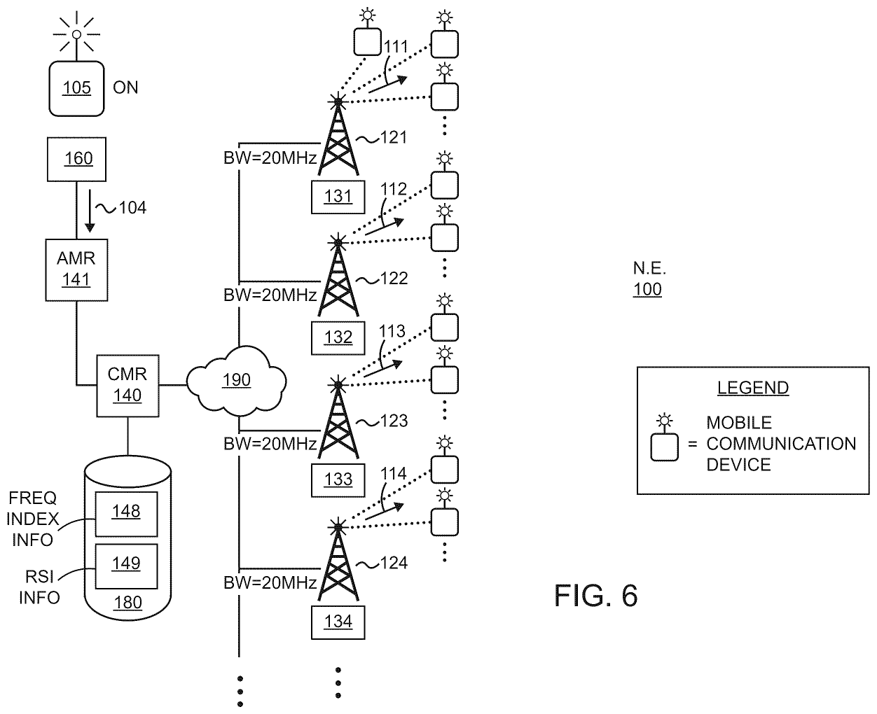

FIG. 6 is an example diagram illustrating a network environment implementing dynamic configuration of frequency index values based on reduced wireless bandwidth allocation as discussed herein.

In this example, the monitor resource 160 detects use of one or more wireless channels by the incumbent entity 105. The monitor resource 160 provides notification of the use of the one or more wireless channels by the incumbent entity 105 to the allocation management resource 141. Because the incumbent entity 105 has higher priority rights to use bandwidth than the first wireless network, the allocation management resource 141 or the communication management resource of the revocation of one or more wireless channels such that the remaining wireless bandwidth allocated to the first wireless network is 20 megahertz.

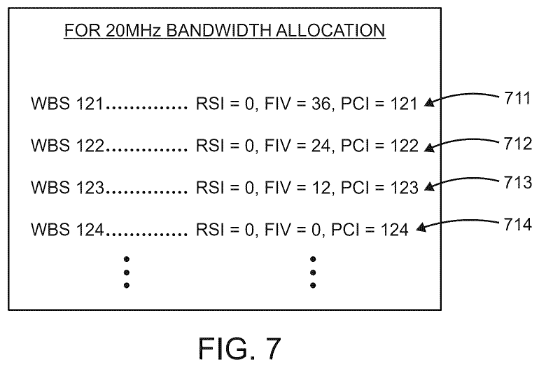

In such an instance, the communication management resource 140 notifies each of the wireless base stations in the first wireless network that bandwidth is been reduced from 40 megahertz to 20 megahertz. As further shown in FIG. 7, in response to the reduction in wireless bandwidth allocated for use by the first wireless network, the communication management resource 140 updates the respective frequency index values assigned to the wireless base stations in the first wireless network.

Recall that allocation of 40 megahertz bandwidth enables use of frequency index values 0, 12, 24, 36, 48, 60, 72, and 84. However, the newly allocated bandwidth of 20 megahertz enables only use of frequency index values 0, 12, 24, and 36. In such an instance, the communication management resource 140 produces the new configuration settings in FIG. 7 to provide notification to the wireless base stations of the newly assigned frequency index values.

FIG. 7 is an example diagram illustrating assignment of different RSI information and frequency index values to different wireless base stations based on allocation of the reduced wireless bandwidth as discussed herein.

Based on allocation of the 20 megahertz, the communication management resource 140 produces respective new configuration settings for each of the wireless base stations in the first wireless network. As previously discussed, it is desirable to assign a unique combination of RSI and frequency index value to each wireless base station in the first wireless network. This ensures that the communication devices attempting to establish wireless connectivity communicate a request in the appropriate manner over the random-access channel 189 to the desirable wireless base station.

In this example, there are 40 possibilities of assigning combinations of on RSI and frequency index value to a respective wireless base station.

For example, based on the allocation of 20 megahertz, the communication management resource 140 generates configuration settings 711 to indicate that the wireless base station 121 has been assigned an RSI of 0, frequency index value 36, PCI (Physical Cell Identity or unique identifier value) of 121, RACH occasion 407, etc. The communication management resource 140 forwards the configuration settings 711 associated with the random-access channel 189 to the wireless base station 121. The wireless base station 121 then broadcasts (such as via communications 111) all or a portion of the configuration settings 711 to any listening communication devices 151. The receiving communication devices are then aware of how to use the random-access channel to obtain wireless resources associated with the wireless base station 121. Any of the communication devices 151 that wish to establish a respective wireless communication link with the wireless base station 121 or obtain uplink wireless resources to communicate with the wireless base station 121 use the received configuration settings 711 (RSI=0, frequency index value=36, etc.) to obtain the wireless uplink resources to communicate with the wireless base station 121. For example, the communication device communicates a request in the RACH occasion 407 of the RACH channel 189 at a frequency associated with the frequency index value 36 using a preamble associated with the RSI value of 0.

Based on the allocation of 20 megahertz, the communication management resource 140 generates configuration settings 712 to indicate that the wireless base station 122 has been assigned an RSI of 0, frequency index value 24, PCI (Physical Cell Identity or unique identifier value) of 122, RACH occasion 407, etc. The communication management resource 140 forwards the configuration settings 712 associated with the random-access channel 189 to the wireless base station 122. The wireless base station 122 then broadcasts (such as via communications 112) all or a portion of the configuration settings 712 to any listening communication devices. The receiving communication devices are then aware of how to use the random-access channel to obtain wireless resources associated with the wireless base station 122. Any of the communication devices 152 that wish to establish a respective wireless communication link with the wireless base station 122 or obtain uplink wireless resources to communicate with the wireless base station 122 use the received configuration settings 712 (RSI=0, frequency index value=24, etc.) to obtain the wireless uplink resources to communicate with the wireless base station 122. For example, the communication device communicates a request in the RACH occasion 407 of the RACH channel 189 at a frequency associated with the frequency index value 24 using a preamble associated with the RSI value of 0.

Based on the allocation of 20 megahertz, the communication management resource 140 generates configuration settings 713 to indicate that the wireless base station 123 has been assigned an RSI of 0, frequency index value 12, PCI (Physical Cell Identity or unique identifier value) of 123, RACH occasion 407, etc. The communication management resource 140 forwards the configuration settings 713 associated with the random-access channel 189 to the wireless base station 123. The wireless base station 123 then broadcasts (such as via communications 113) all or a portion of the configuration settings 713 to any listening communication devices 152. The receiving communication devices are then aware of how to use the random-access channel to obtain wireless resources associated with the wireless base station 123. Any of the communication devices 152 that wish to establish a respective wireless communication link with the wireless base station 123 or obtain uplink wireless resources to communicate with the wireless base station 123 use the received configuration settings 713 (RSI 0, frequency index value=12, etc.) to obtain the wireless uplink resources to communicate with the wireless base station 123. For example, the communication device communicates a request in the RACH occasion 407 of the RACH channel 189 at a frequency associated with the frequency index value 12 using a preamble associated with the RSI value of 0.

Thus, change in the allocated bandwidth results in dynamic allocation/assignment of different frequency index values to the corresponding wireless base stations in the first wireless network. For example, the wireless base station 121 was originally assigned use of the frequency index value 84 when the allocated bandwidth as 40 megahertz. However, the wireless base station 121 was reassigned the frequency index value 36 based on the reduced bandwidth of 20 megahertz.

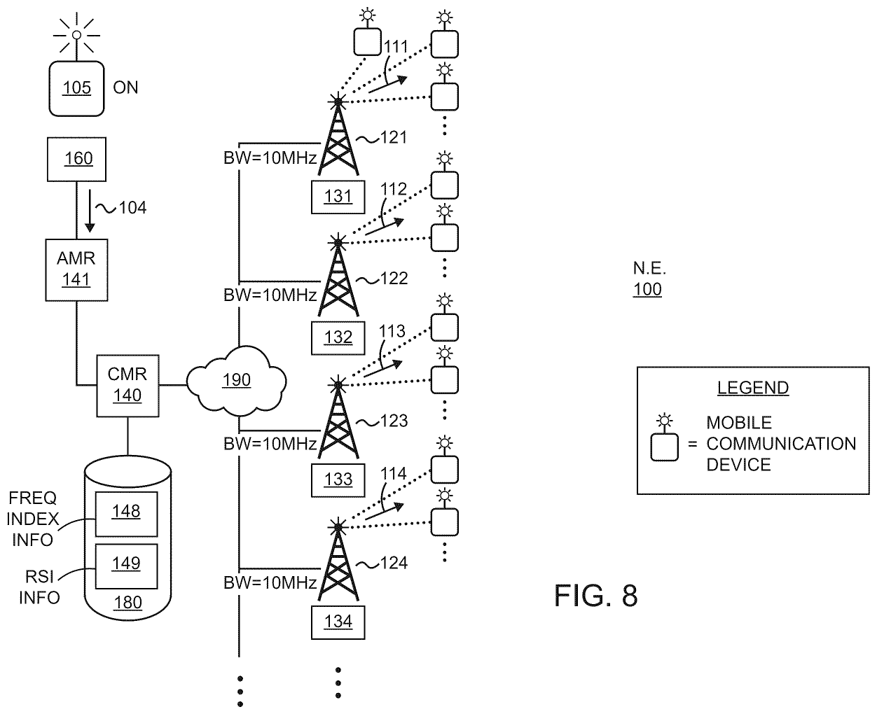

FIG. 8 is an example diagram illustrating a network environment implementing dynamic configuration of frequency index values based on reduced wireless bandwidth allocation as discussed herein.

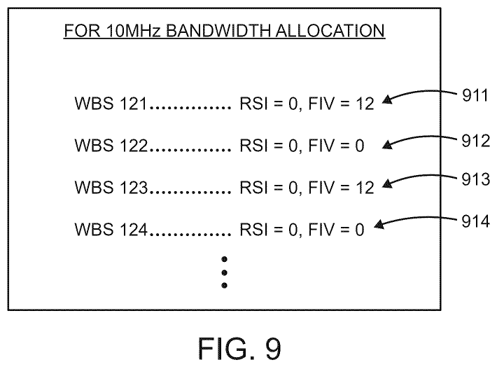

In this example, the monitor resource 160 detects use of one or more wireless channels by the incumbent entity 105. The monitor resource 160 provides notification of the use of the one or more wireless channels by the incumbent entity 105 to the allocation management resource 141. Because the incumbent entity 105 has higher priority rights to use bandwidth than the first wireless network, the allocation management resource 141 or the communication management resource of the revocation of one or more wireless channels such that the remaining wireless bandwidth allocated to the first wireless network is 10 megahertz. In such an instance, the communication management resource 140 notifies each of the wireless base stations in the first wireless network that bandwidth has been reduced from 20 megahertz to 10 megahertz. As further shown in FIG. 9, in response to the reduction in wireless bandwidth allocated for use by the first wireless network, the communication management resource 140 updates the respective frequency index values assigned to the wireless base stations in the first wireless network.

Recall that allocation of 20 megahertz bandwidth enables use of frequency index values 0, 12, 24, and 36. However, the newly allocated bandwidth of 10 megahertz enables only use of frequency index values 0 and 12. In such an instance, the communication management resource 140 produces the new configuration settings in FIG. 9 to provide notification to the wireless base stations of the newly assigned frequency index values.

FIG. 9 is an example diagram illustrating assignment of different RSI information and frequency index values to different wireless base stations based on allocation of the reduced wireless bandwidth as discussed herein.

Based on allocation of the 10 megahertz, the communication management resource 140 produces respective configuration settings for each of the wireless base stations in the first wireless network. As previously discussed, it is desirable to assign a unique combination of RSI value and frequency index value to each wireless base station in the first wireless network. This ensures that the communication devices attempting to establish wireless connectivity communicate a request in the appropriate manner over the random-access channel 189 to the desirable wireless base station.

In this example, there are 20 possibilities of assigning combinations of on RSI value and frequency index value to a respective wireless base station.

For example, based on the allocation of 10 megahertz, the communication management resource 140 generates configuration settings 911 to indicate that the wireless base station 121 has been assigned an RSI of 0, frequency index value 12, PCI (Physical Cell Identity or unique identifier value) of 121, RACH occasion 407, etc. The communication management resource 140 forwards the configuration settings 911 associated with the random-access channel 189 to the wireless base station 121. The wireless base station 121 then broadcasts (such as via communications 111) is all or a portion of the configuration settings 911 to any listening communication devices 151. The receiving communication devices are then aware of how to use the random-access channel to obtain wireless resources associated with the wireless base station 121. Any of the communication devices 151 that wish to establish a respective wireless communication link with the wireless base station 121 or obtain uplink wireless resources to communicate with the wireless base station 121 use the received configuration settings 911 (RSI 0, frequency index value=12, etc.) to obtain the wireless uplink resources to communicate with the wireless base station 121. For example, the communication device communicates a request in the RACH occasion 407 of the RACH channel 189 at a frequency associated with the frequency index value 12 using a preamble associated with the RSI value of 0.

Based on the allocation of 10 megahertz, the communication management resource 140 generates configuration settings 912 to indicate that the wireless base station 122 has been assigned an RSI of 0, frequency index value 0, PCI (Physical Cell Identity or unique identifier value) of 122, RACH occasion 407, etc. The communication management resource 140 forwards the configuration settings 912 associated with the random-access channel 189 to the wireless base station 122. The wireless base station 122 then broadcasts (such as via communications 112) all or a portion of the configuration settings 912 to any listening communication devices. The receiving communication devices are then aware of how to use the random-access channel to obtain wireless resources associated with the wireless base station 122. Any of the communication devices 152 that wish to establish a respective wireless communication link with the wireless base station 122 or obtain uplink wireless resources to communicate with the wireless base station 122 use the received configuration settings 912 (RSI 0, frequency index value=0, etc.) to obtain the wireless uplink resources to communicate with the wireless base station 122. For example, the communication device communicates a request in the RACH occasion 407 of the RACH channel 189 at a frequency associated with the frequency index value 0 using a preamble associated with the RSI value of 0.

Based on the allocation of 10 megahertz, the communication management resource 140 generates configuration settings 913 to indicate that the wireless base station 123 has been assigned an RSI of 13, frequency index value 12, PCI (Physical Cell Identity or unique identifier value) of 123, RACH occasion 407, etc. The communication management resource 140 forwards the configuration settings 913 associated with the random-access channel 189 to the wireless base station 123. The wireless base station 123 then broadcasts all or a portion of the configuration settings 913 to any listening communication devices. The receiving communication devices are then aware of how to use the random-access channel to obtain wireless resources associated with the wireless base station 123. Any of the communication devices 153 that wish to establish a respective wireless communication link with the wireless base station 123 or obtain uplink wireless resources to communicate with the wireless base station 123 use the received configuration settings 913 (RSI 13, frequency index value=12, etc.) to obtain the wireless uplink resources to communicate with the wireless base station 123. For example, the communication device communicates a request in the RACH occasion 407 of the RACH channel 189 at a frequency associated with the frequency index value 12 using a preamble associated with the RSI value of 13.

Thus, change in the allocated bandwidth results in dynamic allocation/assignment of different frequency index values to the corresponding wireless base stations in the first wireless network. For example, the wireless base station 121 was originally assigned use of the frequency index value 36 when the allocated bandwidth was 20 megahertz. However, the wireless base station 121 was reassigned the frequency index value 12 based on the reduced bandwidth of 10 megahertz.

In this manner, the communication management resource 140 then dynamically updates the frequency index values assigned for use by each of the wireless base station when there is a change in allocated bandwidth.

Referring again to FIG. 1, assume that the monitor resource 160 no longer detects use of and the wireless channels (wireless bandwidth) by the incumbent entity 105. In such an instance, the allocation management resource 141 notifies the communication management resource 140 of the wireless bandwidth of 40 megahertz for use in the first wireless network again. In such an instance, the communication manager resource 140 produces the configuration settings as shown in FIG. 5 and transmits such information to each of the wireless base stations in a manner as previously discussed to notify them of their newly assigned frequency index value.

As discussed herein, the dynamic update to the frequency index values and notification of same to wireless base stations and corresponding communication devices ensures that the wireless base stations or communication devices do not improperly use outdated frequency index values. For example, assume that the wireless base station 121 is initially assigned the frequency index value 84 during a condition in which 40 megahertz is assigned for use by the first wireless network and corresponding wireless base stations. During a reduction of wireless bandwidth to 20 megahertz or 10 megahertz, the frequency index value of 84 is no longer usable to communicate over the random-access channel to the respective wireless base station. Without reassignment of the frequency index value based on the newly allocated wireless bandwidth as discussed herein, the mobile communication devices would not be able to request wireless uplink resources from the respective wireless base station.

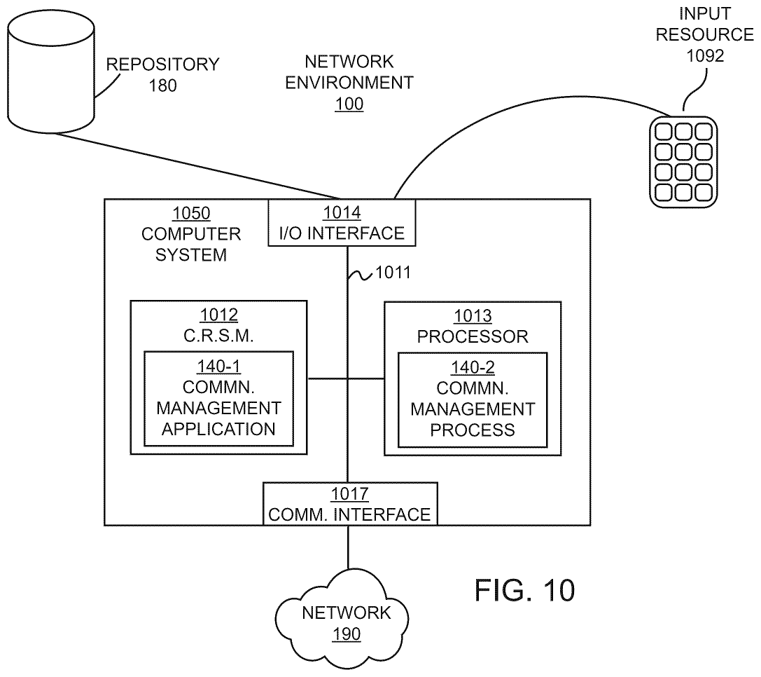

FIG. 10 is an example block diagram of a computer system for implementing any of the operations as previously discussed according to examples herein.

Note that any of the resources (such as allocation management resource 141, communication management resource 140, wireless base station 121, wireless base station 122, wireless station 123, wireless base station 124, etc., communication management resource 131, communication management resource 132, communication management resource 133, communication management resource 134, etc.) as discussed herein can be configured to include computer processor hardware and/or corresponding executable instructions to carry out the different operations as discussed herein.

For example, as shown, computer system 1050 of the present example includes interconnect 1011 coupling computer readable storage media 1012 such as a non-transitory type of media or computer readable storage hardware (which can be any suitable type of resource in which digital information can be stored and or retrieved), a processor 1013 (computer processor hardware), I/O interface 1014, and a communications interface 1017.

I/O interface(s) 1014 supports connectivity to repository 1080 and input resource 1092.

Computer readable storage medium 1012 can be any hardware storage device such as memory, optical storage, hard drive, floppy disk, etc. In one example, the computer readable storage medium 1012 stores instructions and/or data.

As shown, computer readable storage media 1012 can be encoded with communication management application 140-1 in a respective one or more network nodes to carry out any of the operations as discussed herein.

During operation of one example, processor 1013 accesses computer readable storage media 1012 via the use of interconnect 1011 in order to launch, run, execute, interpret or otherwise perform the instructions in management application 140-1 stored on computer readable storage medium 1012. Execution of the management application 140-1 produces management process 140-2 to carry out any of the operations and/or processes as discussed herein.

Those skilled in the art will understand that the computer system 1050 can include other processes and/or software and hardware components, such as an operating system that controls allocation and use of hardware resources to execute the management application 140-1.

In accordance with different examples, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1050 may reside at any location or can be included in any suitable resource in any network environment to implement functionality as discussed herein.

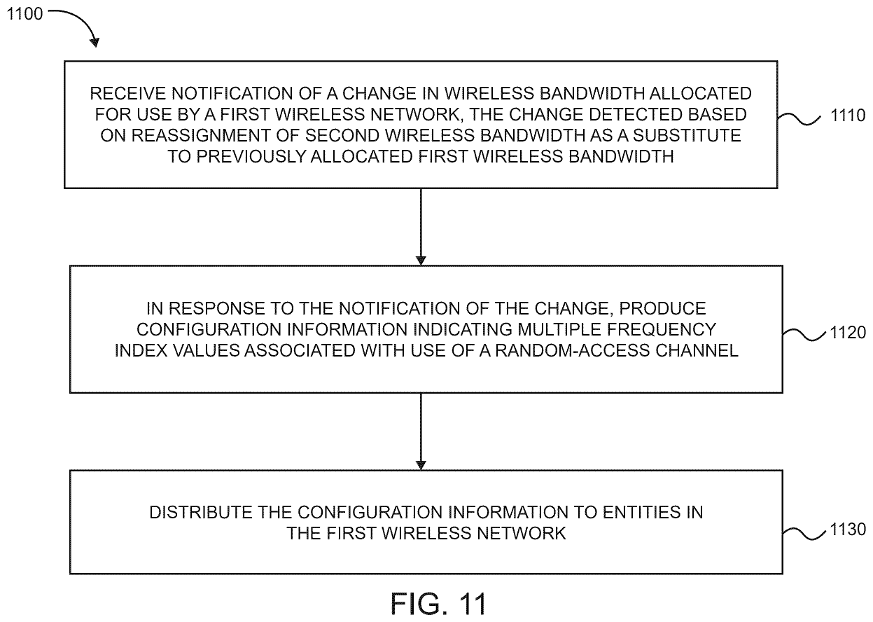

Functionality supported by the different resources will now be discussed via flowchart 1100 in FIG. 11. Note that the steps in the flowcharts below can be executed in any suitable order.

FIG. 11 is a flowchart 1100 illustrating an example method according to examples herein. Note that there will be some overlap with respect to concepts as discussed above.

In processing operation 1110, the communication management resource 140 receives notification of a change in wireless bandwidth allocated for use by a first wireless network including multiple wireless base stations. The change in wireless bandwidth is detected based on reassignment of second wireless bandwidth as a substitute to previously allocated first wireless bandwidth. For example, as previously discussed, the allocation management resource 141 initially allocates use of 40 megahertz of bandwidth for use by the first wireless network. The allocated wireless bandwidth may be reduced from 40 megahertz to 20 megahertz or 10 megahertz.

In processing operation 1120, in response to the notification of the change in wireless bandwidth, the communication management resource 140 produces configuration information such as configuration settings (such as configuration settings 711, configuration settings 712, configuration settings 713, etc.) indicating multiple frequency index values associated with use of a random-access channel. The configuration settings may include: i) first configuration settings 711 assigned to the wireless base station 121, ii) second configuration settings 712 assigned to the wireless base station 122, etc.

In processing operation 1130, the communication management resource 140 or other suitable entity distributes the configuration information (new configuration settings 711, 712, 713, etc.) to entities in the first wireless network. As previously discussed, this may include wireless communication of first communications (including the first configuration settings 711) from the communication management resource 140 to the wireless base station 121, wireless communication of second communications (including the second configuration settings 712) from the communication management resource 140 to the wireless base station 122, etc. As further discussed herein, the wireless base stations communicate the received configuration settings to respective mobile communication devices so that they can use the random-access channel to communicate with the respective wireless base station.

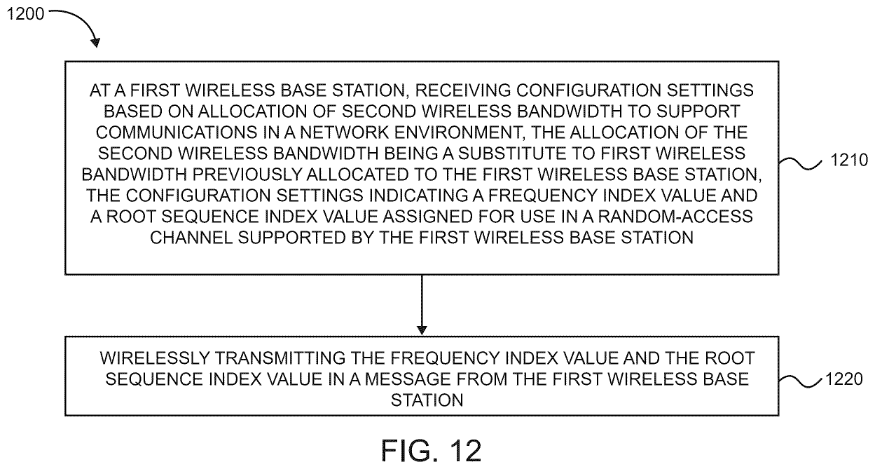

FIG. 12 is a flowchart 1200 illustrating an example method according to examples herein. Note that there will be some overlap with respect to concepts as discussed above.

In processing operation 1210, the communication management resource 131 associated with the wireless base station 121 receives configuration settings 711 as a replacement to configuration settings 511. The configuration settings 711 can be configured to indicate or be based on allocation of second wireless bandwidth (20 megahertz) to support communications in a network environment. The allocation of the second wireless bandwidth (20 megahertz) may be a substitute to first wireless bandwidth (40 megahertz) and configuration settings 511 (frequency index value 84 and root sequence index value 0) previously allocated to the first wireless base station 121. The new configuration settings 711 associated with the 20 megahertz allocation indicate indicating a first frequency index value 36 and a first root sequence index 0 assigned for use in a random-access channel supported by the first wireless base station 121.

In processing operation 1220, the wireless base station 121 wirelessly transmits the configuration settings 711 in a message from the first wireless base station to one or more mobile communication devices in the network environment 100. As previously discussed, the configuration settings 711 notify any receiving mobile communication device how to use the random-access channel to establish a new wireless communication link with a wireless base station 121. Thus, any communication devices use the appropriate index value 36 instead of the frequency index value 84 to communicate over the random-access channel on establish a respective wireless vacation link with the wireless base station 121. Without reassignment of the frequency index value 36, the communication devices when still use frequency index value 84 not be able to communicate a link request to the respective wireless base station.

Note again that techniques herein are well suited to facilitate dynamic reassignment of frequency index values based on a magnitude of allocated wireless bandwidth for use in the network environment. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this example has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

We claim:

1. A method comprising:
receiving notification of a change in wireless bandwidth allocated for use by a first wireless network, the change detected based on reassignment of second wireless bandwidth as a substitute to previously allocated first wireless bandwidth;
in response to the notification of the change, producing configuration information indicating multiple frequency index values associated with use of a random-access channel; and
distributing the configuration information to entities in the first wireless network.

2. The method as in claim 1, wherein the change in the wireless bandwidth allocated for use by the first wireless network occurs in response to detected use of the first wireless bandwidth by an incumbent entity having higher priority rights than the first wireless network.

3. The method as in claim 1, wherein distributing the configuration information includes:
communicating the configuration information indicating the multiple frequency index values to multiple wireless base stations in the first wireless network, the first wireless network operated by a first service provider.

4. The method as in claim 3, wherein the multiple frequency index values include a number, N, frequency index values, where the number N is an integer value proportional to a magnitude of the second bandwidth.

5. The method as in claim 1, wherein each of the multiple frequency index values is an offset frequency value.

6. The method as in claim 1 further comprising:
receiving the notification of the change in the wireless bandwidth from an allocation management resource operative to allocate use of bandwidth to multiple wireless networks including the first wireless network and a second wireless network.

7. The method as in claim 1, wherein the communication management resource is implemented in a host domain proxy allocating use of wireless channels from a tiered priority allocation system.

8. The method as in claim 1, wherein producing the configuration information includes:
producing the configuration information to include first configuration settings and a second configuration settings, the first configuration settings including a first assigned RSI (Root Sequence Index) option, the second configuration settings including a second assigned RSI option.

9. The method as in claim 8, wherein communicating the configuration information to the first wireless network includes:
transmitting the first configuration settings to a first wireless base station in the first wireless network; and
transmitting the second configuration settings to a second wireless base station in the first wireless network.

10. The method as in claim 1, wherein the random-access channel is allocated for use by multiple communication devices to establish a respective wireless communication link with multiple wireless base stations in the first wireless network.

11. A method comprising:
at a first wireless base station, receiving configuration settings based on allocation of second wireless bandwidth to support communications in a network environment, the allocation of the second wireless bandwidth being a substitute to first wireless bandwidth previously allocated to the first wireless base station, the configuration settings indicating a frequency index value and a root sequence index value assigned for use in a random-access channel supported by the first wireless base station; and
wirelessly transmitting the frequency index value and the root sequence index value in a message from the first wireless base station.

12. The method as in claim 11, wherein the message includes a unique identifier value assigned to the first wireless base station, the message indicating how to communicate with the first wireless base station over the random-access channel to establish a wireless communication link.

13. The method as in claim 11, wherein the second wireless bandwidth is allocated for use by the first wireless base station in response to detected use of the first wireless bandwidth by an incumbent entity having higher priority rights with respect to use of the first wireless bandwidth than the first wireless base station.

14. The method as in claim 11, wherein wirelessly transmitting the frequency index value and the root sequence index value in a message includes broadcasting the message from the first wireless base station.

15. The method as in claim 11, wherein the frequency index value is selected from a number N frequency index values, where the number N is an integer value proportional to an amount of the second wireless bandwidth.

16. The method as in claim 11, wherein the frequency index value specifies an offset with respect to a base frequency value.

17. A system comprising:
communication management hardware operative to:
receive notification of a change in wireless bandwidth allocated for use by a first wireless network, the change detected based on reassignment of second wireless bandwidth as a substitute to previously allocated first wireless bandwidth;
in response to the notification of the change, produce configuration information indicating multiple frequency index values associated with use of a random-access channel; and
distribute the configuration information to entities in the first wireless network.

18. The system as in claim 17, wherein the change in the wireless bandwidth allocated for use by the first wireless network occurs in response to detected use of the first wireless bandwidth by an incumbent entity having higher priority rights than the first wireless network.

19. The system as in claim 17, wherein the communication management hardware is further operative to:
communicate the configuration information indicating the multiple frequency index values to multiple wireless base stations in the first wireless network, the first wireless network operated by a first service provider.

20. The system as in claim 19, wherein the multiple frequency index values include a number, N, frequency index values, where the number N is an integer value proportional to a magnitude of the second bandwidth.

21. The system as in claim 17, wherein each of the multiple frequency index values is an offset frequency value.

22. The system as in claim 17, wherein the communication management hardware is further operative to:
receive the notification of the change in the wireless bandwidth from an allocation management resource operative to allocate use of bandwidth to multiple wireless networks including the first wireless network and a second wireless network.

23. Computer-readable storage hardware having instructions stored thereon, the instructions, when carried out by computer processor hardware, cause the computer processor hardware to:
receive notification of a change in wireless bandwidth allocated for use by a first wireless network, the change detected based on reassignment of second wireless bandwidth as a substitute to previously allocated first wireless bandwidth;
in response to the notification of the change, produce configuration information indicating multiple frequency index values associated with use of a random-access channel; and
distribute the configuration information to entities in the first wireless network.
